(19) United States
(12) Patent Application Publication
(10) Pub. No.: US 2026/0318695 A1
(43) Pub. Date: Oct. 15, 2026

(54) GUIDANCE SYSTEM, GUIDANCE METHOD, AND PROGRAM

(71) Applicant: NEC Corporation, Tokyo (JP)

(72) Inventors: Takahiro MIZUTA, Tokyo (JP); Kenichi KIJIMA, Tokyo (JP); Tetsuya TANABIK!, Tokyo (JP); Elicch TOKUMI, Tokyo (JP); Taichi SEISHI, Tokyo (JP); Takuya NOMURA, Tokyo (JP); Takumi KAMIYAMA, Tokyo (JP)

(73) Assignee: NEC Corporation, Tokyo (JP)

(21) Appl. No.: 19/481,927

(22) PCT Filed: Apr. 19, 2024
(86) PCT No.: PCT/JP2024/015603

§ 371 Date: Nov. 6, 2025

(30) Foreign Application Priority Data
May 29, 2023 (JP) 2023-087592

(51) Int. Cl. G01C 21/34; G01C 21/36

(52) U.S. Cl. CPC G01C 21/3423; G01C 21/3691

(57) ABSTRACT

A user information acquisition unit in the guidance system acquires user information including a route along which a moving body flying in the sky and transporting a user transports the user, the destination of the user, and the route of another movement portion used by the user. A route information acquisition unit acquires a possible route of movement for the moving body from a predetermined database. A condition acquisition unit acquires movement conditions including environment information regarding the possible route of movement. A route setting unit resets the route to an alternative location on the basis of the user information, the possible route of movement, and the movement conditions in the event that the initial arrival location of the moving body is changed to the alternative location. An output unit outputs a route to the alternative location as per the reset to the user.

### TECHNICAL FIELD

The present disclosure relates to a guidance system, a guidance method, and a program.

### BACKGROUND ART

There has been an increase in the use of moving bodies that fly at lower altitudes than conventional aircraft, such as drones and flying cars. In such a situation, the use of flying car as one of transportation means for transporting the user, efficient operation is expected.

For example, a flight path generation device of PTL 1 collects information of a plurality of flying objects capable of autonomous flight, acquires information regarding scheduled take-off time and a destination, generates a flight path from a take-off place to a landing place corresponding to the destination based on the information, and transmits the flight path to the flying object.

An information processing device of PTL 2 stores setting information in which port identification information, a use condition, and an available period are associated with each other, receives user information and a use date and time from a user terminal, determines whether a port is available based on the user information and the use date and time, and outputs a determination result to the user terminal.

In addition, a flight map data generation method of PTL 3 includes acquiring position information of a road in a position information acquiring step, setting the position information and an altitude in such a way that a flyable space lies along the road in a flyable space setting step, and generating flight map data in a flight map data generating step.

### CITATION LIST

### Patent Literature

PTL 1: WO 2021/210139 A1
PTL 2: JP 2022-117085 A
PTL 3: JP 2022-028131 A

### SUMMARY OF INVENTION

However, there is a possibility that a moving body such as a flying car cannot operate on the initial scheduled route.

In view of the above-described problem, an object of the present disclosure is to provide a guidance system and the like that can set an efficient movement route.

A guidance system according to the present disclosure includes a user information acquisition unit, a route information acquisition unit, a condition acquisition unit, a route setting unit, and a presentation unit. The user information acquisition unit acquires user information including a route along which a moving body flying in the sky and transporting a user transports the user, a destination of the user, and a route of another movement means used by the user. The route information acquisition unit acquires a possible movement route of the moving body from a predetermined database. The condition acquisition unit acquires a movement condition including environment information of the possible movement route. The route setting unit resets, upon changing an initial arrival location of the moving body to an alternative location, a route to the alternative location based on the user information, the possible movement route, and the movement condition. The presentation unit presents a route to the alternative location related to the resetting to the user.

In a guidance method according to the present disclosure, a computer executes the following processing. The computer acquires user information including a route along which a moving body flying in the sky and transporting a user transports the user, a destination of the user, and a route of another movement means used by the user. The computer acquires a possible movement route of the moving body from a predetermined database. The computer acquires a movement condition including environment information of the possible movement route. The computer resets, upon changing an initial arrival location of the moving body to an alternative location, a route to the alternative location based on the user information, the possible movement route, and the movement condition. The computer presents a route to the alternative location related to the resetting to the user.

A program according to the present disclosure causes a computer to execute the following guidance method. The computer acquires user information including a route along which a moving body flying in the sky and transporting a user transports the user, a destination of the user, and a route of another movement means used by the user. The computer acquires a possible movement route of the moving body from a predetermined database. The computer acquires a movement condition including environment information of the possible movement route. The computer resets, upon changing an initial arrival location of the moving body to an alternative location, a route to the alternative location based on the user information, the possible movement route, and the movement condition. The computer presents a route to the alternative location related to the resetting to the user.

According to the present disclosure, it is possible to provide a guidance system, a guidance method, and a program capable of setting an efficient movement route.

### BRIEF DESCRIPTION OF DRAWINGS

FIG. 1 is a first block diagram of a guidance system according to the present disclosure.

FIG. 2 is a flowchart of a guidance method executed by the guidance system.

FIG. 3 is a first block diagram of an operation system.

FIG. 4 is a second block diagram of the guidance system.

FIG. 5 is a schematic configuration diagram of a moving body.

FIG. 6 is a block diagram of the moving body.

FIG. 7 is a second flowchart of the guidance method executed by the guidance system.

FIG. 8 is a third flowchart of the guidance method executed by the guidance system.

FIG. 9 is a diagram for explaining a set route.

FIG. 10 is a second block diagram of an operation system.

FIG. 11 is a third block diagram of the guidance system.

FIG. 12 is a fourth flowchart of the guidance method executed by the guidance system.

FIG. 13 is a fifth flowchart of the guidance method executed by the guidance system.

FIG. 14 is a block diagram exemplifying a hardware configuration of a computer.

### EXAMPLE EMBODIMENT

Hereinafter, the present invention will be described through example embodiments of the invention, but the invention according to the claims is not limited to the following example embodiments. Not all the configurations described in the example embodiments are essential as means for solving the problem. For clarity of description, the following description and drawings are omitted and simplified as appropriate. In each drawing, the same elements are denoted by the same reference numerals, and repetitive description is omitted as necessary.

### First Example Embodiment

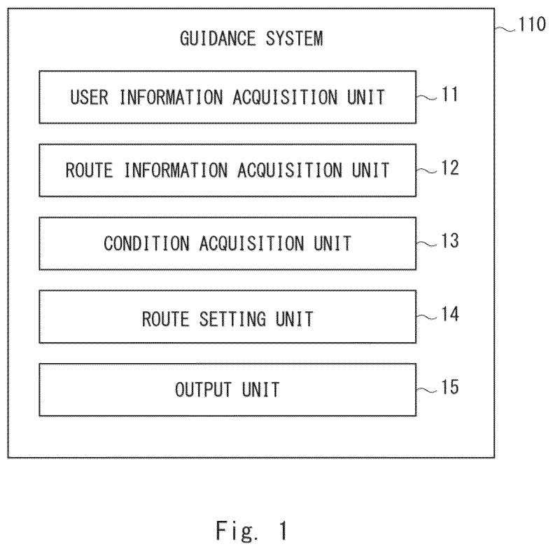

Hereinafter, a first example embodiment will be described. FIG. 1 is a block diagram of a guidance system 110. The guidance system 110 can be configured by a device having a communication function and an arithmetic processing function, such as a computer, a tablet terminal, or a smartphone. With the communication function, the guidance system 110 can acquire various types of information to be described later, process the acquired information, and output a processing result.

The guidance system 110 achieves guidance of a route combining a plurality of transportation means for movement of a traveler who is a user. The route guidance achieved by the guidance system 110 includes a predetermined moving body. The moving body transports about one to several passengers. The moving body is referred to as, for example, a flying car. The flying car takes off and lands at a preset take-off and landing site and moves in the sky of about several hundred meters.

In addition, the guidance system 110 resets the place of landing and the route in the event that a situation occurs in which the moving body changes the route while transporting the user. The guidance system 110 includes, as main configurations, a user information acquisition unit 11, a route information acquisition unit 12, a condition acquisition unit 13, a route setting unit 14, and an output unit 15.

The user information acquisition unit 11 acquires user information. The user information in the present disclosure includes a route along which a moving body flying in the sky and transporting the user transports the user, a destination of the user, and a route of another movement means used by the user. The route on which the moving body transports the user includes a take-off site and a landing site. For example, the user information acquisition unit 11 may acquire the user information by the user directly inputting information to the guidance system 110, or may receive the user information from another system.

The route information acquisition unit 12 acquires a possible movement route of the moving body from a predetermined database. The possible movement route is a route along which the moving body can move. The moving body moves on a route permitted in advance. The possible movement route can be set according to the type of the moving body. In addition, the possible movement route may vary according to weather or traffic regulation situation.

The condition acquisition unit 13 acquires movement condition including environment information of the possible movement route. The environment condition is, for example, weather information, traffic regulation information, and congestion information of moving bodies. Furthermore, the movement condition may include a condition corresponding to the performance or type of the moving body in addition to the environment information. For example, in a route set in the sky above a region where there are many pedestrians, entry of a moving body transporting a dangerous article is restricted.

In a case where the initial arrival location of the moving body is changed to an alternative location, the route setting unit 14 resets the route to the alternative location. For example, the route setting unit 14 changes the place of landing from a situation in which the landing site is unavailable due to reasons such as stormy weather. The route setting unit 14 resets the route to the alternative location based on the user information, the possible movement route, and the movement conditions described above.

The route setting unit 14 searches for alternative location candidates for the user to move to the destination from, for example, the user information and the possible movement route. Furthermore, the route setting unit 14 selects a possible movement route from the movement conditions. The route setting unit 14 sets one or more routes for the user to move to the destination from the above information.

The output unit 15 outputs the route to the alternative location related to the resetting to the user. In a case where an operator is maneuvering the moving body, the output unit 15 outputs a route to the alternative location in a mode that can be recognized by the operator.

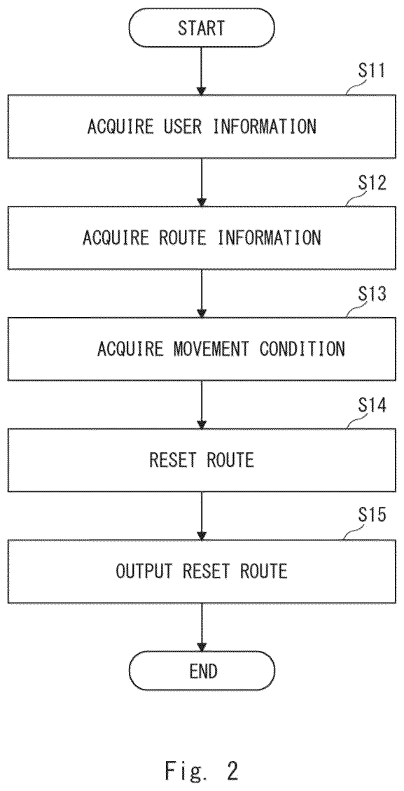

Next, processing executed by the guidance system 110 will be described with reference to FIG. 2. FIG. 2 is a flowchart of a guidance method executed by the guidance system 110. The flowchart illustrated in FIG. 2 starts, for example, by the guidance system 110 determining to change the place of landing.

First, the user information acquisition unit 11 acquires user information including a route along which a moving body flying in the sky and transporting the user transports the user, a destination of the user, and a route of another movement means used by the user (step S11). The user information acquisition unit 11 supplies the acquired user information to the route setting unit 14.

Next, the route information acquisition unit 12 acquires a possible movement route of the moving body from a predetermined database (step S12). The route information acquisition unit 12 supplies the acquired possible movement route to the route setting unit 14.

Next, the condition acquisition unit 13 acquires the movement condition including the environment information of the possible movement route (step S13). The condition acquisition unit 13 supplies the acquired movement condition to the route setting unit 14.

Next, in a case where the initial arrival location (i.e., the place of landing) of the moving body is changed to the alternative location, the route setting unit 14 resets the route to the alternative location based on the user information, the possible movement route, and the movement condition (step S14). After resetting the route to the alternative location, the route setting unit 14 supplies information regarding the reset route to the output unit 15.

Next, the output unit 15 outputs, to the user, the route to the alternative location related to the resetting (step S15). When the output unit 15 outputs the information regarding the reset route, the guidance system 110 ends a series of processing.

The configuration of the guidance system 110 and the processing executed by the guidance system 110 have been described above. The guidance system 110 may include a processor and a storage device as a configuration not illustrated. The storage device included in the guidance system 110 may be, for example, a storage device including a nonvolatile memory such as a flash memory or a Solid State Drive (SSD). In this case, the storage device included in the guidance system 110 stores a computer program (hereinafter, also simply referred to as a program) for executing the above-described image processing method. Furthermore, the processor reads the computer program from the storage device into a buffer memory such as a Dynamic Random Access Memory (DRAM), and executes the program.

Each constituent of the guidance system 110 may be achieved by dedicated hardware. Some or all of the constituent components may be implemented by general-purpose or dedicated circuitry, a processor, or the like, or a combination thereof. These may be configured with a single chip or may be configured with a plurality of chips connected via a bus. Some or all of the constituent components of each device may be implemented by a combination of the above-described circuitry or the like and a program. Furthermore, as the processor, a Central Processing Unit (CPU), a Graphics Processing Unit (GPU), a field-programmable gate array (FPGA), or the like may be used. In addition, the description regarding the configuration described herein can also be applied to other devices or systems described below in the present disclosure.

With the above-described configuration, in a case where the user uses a plurality of transportation means, in the event that the initial place of landing of the moving body is changed, the guidance system 110 sets an alternative location and a movement route in consideration of the use of the plurality of transportation means. Accordingly, the guidance system 110 can provide a predetermined benefit to the user as, for example, a Mobility as a Service (MaaS). That is, the guidance system 110 sets a route combining a plurality of public transportations or the like in response to the user's movement in units of trips. By resetting the route across the plurality of transportation means in this manner, the guidance system 110 can contribute to reduction of the emission amount of carbon dioxide in the entire transportation means. In addition, the guidance system 110 can contribute to mitigation of traffic congestion.

The above-described moving body may be one in which an operator maneuvers the moving body, or may be one in which a user is transported by automatic maneuvering. The moving body may be a helicopter instead of the flying car. The moving body preferably performs vertical take-off and landing. That is, the moving body is preferably one that is referred to as a vertical take-off and landing vehicle or vertical take-off and landing aircraft (VTOL). In this case, the take-off and landing site is also referred to as, for example, a vertiport or a vertical take-off and landing airport. The take-off and landing site can be referred to as a take-off port in the event that the moving body takes off. The take-off and landing site can be referred to as a landing port in the event that the moving body lands.

As described above, according to the present disclosure, it is possible to provide a guidance system, a guidance method, and a program capable of setting an efficient movement route.

### Second Example Embodiment

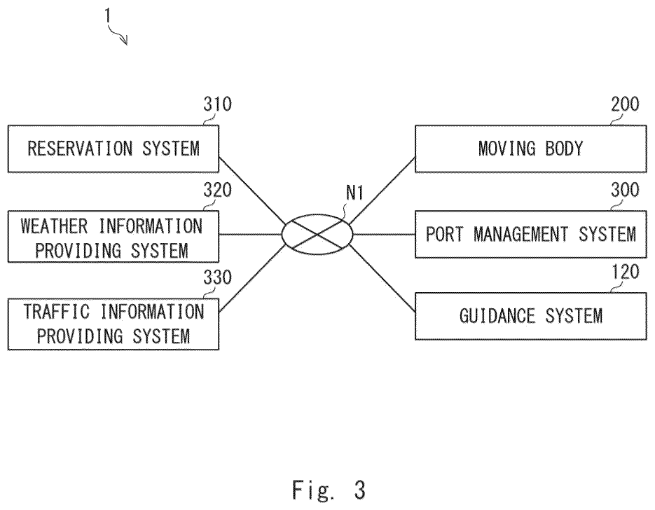

Next, a second example embodiment will be described. FIG. 3 is a block diagram of an operation system 1. The operation system 1 includes, as main configurations, a guidance system 120, a moving body 200, a port management system 300, a reservation system 310, a weather information providing system 320, and a traffic information providing system 330. The operation system 1 illustrates a configuration for resetting a route in a case where an arrival port of the moving body 200 transporting a user becomes unavailable.

The guidance system 120 included in the operation system 1 is communicably connected to other configurations via a network N1. The guidance system 120 may acquire user information from the moving body 200. In addition, the guidance system 120 can acquire information regarding the machine body of the moving body from the moving body 200 as one of the conditions acquired by the condition acquisition unit 13.

The guidance system 120 may also acquire information regarding whether a landing port scheduled to arrive is available from the port management system 300. That is, in a case where the landing port scheduled to be used by the moving body 200 becomes unavailable, the guidance system 120 can acquire information that the landing port has become unavailable from the port management system 300. In addition, the guidance system 120 can acquire, from the port management system 300, information on whether the landing port serving as the alternative location is available at the time of resetting the route.

The guidance system 120 registers the set route in the reservation system 310. Furthermore, in searching for a route, the guidance system 120 searches for an available route and an available landing port with reference to the information of the reservation system 310.

The guidance system 120 acquires weather information of the possible movement route of the moving body 200 and the surrounding area of the possible movement route of the moving body 200 from the weather information providing system 320. The guidance system 120 may output a request signal to the weather information providing system 320 and acquire weather information as a response to the request signal, or may appropriately receive a notification of weather information from the weather information providing system 320.

The guidance system 120 acquires traffic information relating to the possible movement route of the moving body 200 from the traffic information providing system 330. The traffic information provided by the traffic information providing system 330 may include a flight condition of a flying car and an unmanned aerial vehicle referred to as an Unmanned Aircraft Systems (UAS) or a drone. Furthermore, the traffic information may include information on other transportation means to be transferred from the moving body 200.

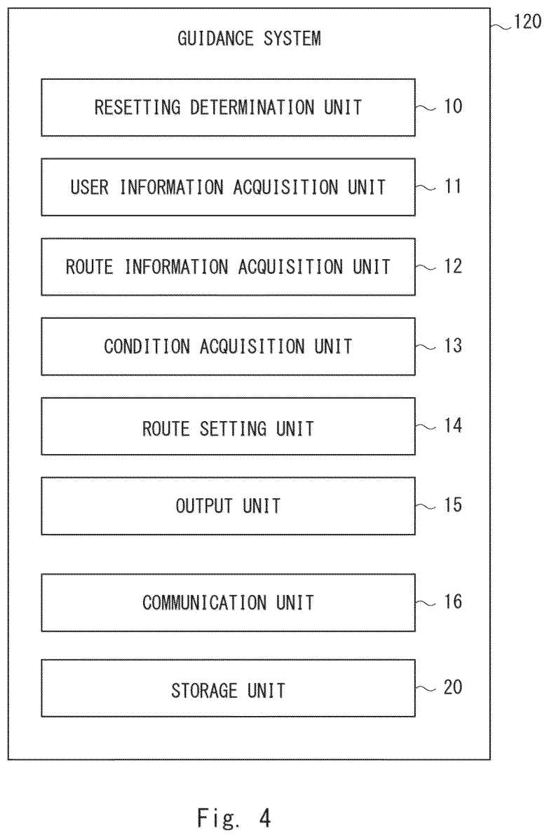

Next, the guidance system 120 will be further described with reference to FIG. 4. FIG. 4 is a block diagram of the guidance system 120. The guidance system 120 includes, as main configurations, a resetting determination unit 10, a user information acquisition unit 11, a route information acquisition unit 12, a condition acquisition unit 13, a route setting unit 14, an output unit 15, a communication unit 16, and a storage unit 20.

The resetting determination unit 10 determines whether to reset the route of the moving body 200 that is moving. The resetting determination unit 10 can perform the above-described determination based on the weather information received from the weather information providing system 320. The resetting determination unit 10 may also perform the above-described determination based on the information regarding the situation of the landing port received from the port management system 300. Alternatively, in a case where a user U1 inputs user information for changing the route to an operation block 220, the resetting determination unit 10 can perform the above-described determination by accepting the updated user information from the operation block 220.

The user information acquisition unit 11 of the guidance system 120 acquires user information from the moving body 200. In this case, for example, the user boards the moving body 200 and inputs information such as the final destination from the operation block provided in the moving body 200. Furthermore, the user information acquisition unit 11 can acquire user information relating to resetting of the route from the operation block 220.

The route information acquisition unit 12 acquires the position of the take-off and landing site of the moving body 200 including an alternative location for resetting the route and the time required by the user for take-off and landing. The route information acquisition unit 12 may acquire the time required by the user for take-off and landing from the storage unit 20. In addition, the route information acquisition unit 12 may acquire the time required by the user for take-off and landing from the port management system 300. With such a configuration, the guidance system 120 can reset a route including transfer to transportation means used after the user gets off the moving body 200.

The condition acquisition unit 13 of the guidance system 120 acquires weather information of a route of the moving body 200 from the weather information providing system 320. The condition acquisition unit 13 acquires, as the weather information, at least one piece of information among wind speed, fog, rainfall, snowfall, and yellow sand.

In this case, the route setting unit 14 of the guidance system 120 resets the route based on the weather information at the scheduled time at which the moving body 200 exists in the route to the alternative location. In addition, the route setting unit 14 selects an alternative location where the moving body 200 can land based on the weather at the scheduled time at which the moving body 200 lands on the alternative location.

The condition acquisition unit 13 may further acquire information regarding the moving ability of the moving body 200. The information regarding the moving ability may include, for example, a moving speed or a moving acceleration that can be exhibited by the moving body 200. The information regarding the moving ability may include, for example, a wind speed at which the moving body 200 can normally operate and a viewing condition that can be guaranteed in the operation of the moving body 200. In this case, the route setting unit 14 resets the route in further consideration of the moving ability of the moving body 200.

In a case where the landing port cannot be used, the route setting unit 14 performs resetting including transfer between the alternative location and another movement means. As a result, the guidance system 120 can collectively reset the routes extending over the plurality of transportation means including the moving body 200.

The output unit 15 of the guidance system 120 outputs a route to a destination including an alternative location related to the resetting to the user. More specifically, the output unit 15 outputs a route to a destination including an alternative location to the moving body 200. As a result, the user using the moving body 200 recognizes the route related to the resetting. In addition, if the operator is maneuvering the moving body 200, the operator maneuvers the moving body 200 along a route related to the resetting supplied from the guidance system 120.

The communication unit 16 includes an interface for communicating with each component via the network N1. The communication unit 16 receives, for example, information indicating that the landing port cannot be used from the port management system 300. Upon receiving information indicating that the landing port cannot be used, the communication unit 16 supplies this information to the route setting unit 14.

The storage unit 20 is a storage device including a nonvolatile memory such as a flash memory, a Solid State Drive (SSD), or a Hard Disk Drive (HDD). The storage unit 20 stores, for example, a program for the guidance system 120 to exhibit the function according to the present disclosure. Furthermore, the storage unit 20 temporarily stores, for example, various types of information acquired by the guidance system 120.

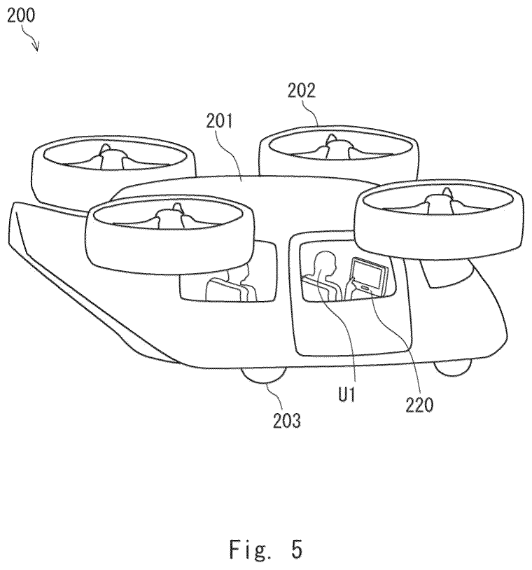

Next, the moving body 200 will be described. FIG. 5 is a schematic configuration diagram of the moving body 200. The moving body 200 includes, as main hardware configurations, a cabin 201, a propeller unit 202, a traveling unit 203, and an operation block 220.

The cabin 201 accommodates at least the user U1 who uses the moving body 200. In addition, the cabin 201 also accommodates an operator if the operator who maneuvers the moving body 200 rides on the cabin. In the cabin 201, the operation block 220 is installed in such a mode that the user U1 can input user information.

The propeller unit 202 includes a propeller and a motor for driving the propeller. The propeller unit 202 is set in such a way that the moving body 200 can fly by rotating a plurality of propellers. The moving body 200 illustrated in the drawing has four propeller units 202. The traveling unit 203 includes a plurality of tires for the moving body 200 to travel on the ground, and a motor for driving at least one of the tires.

The operation block 220 is a terminal device including an interface for the user U1 to input user information. The operation block 220 is a computer having a communication function. The operation block 220 is installed in the cabin 201. The operation block 220 may be dispersedly arranged on the moving body 200 or may be arranged at one place. The operation block 220 may be separable from the moving body 200 or may be integrated with the moving body 200.

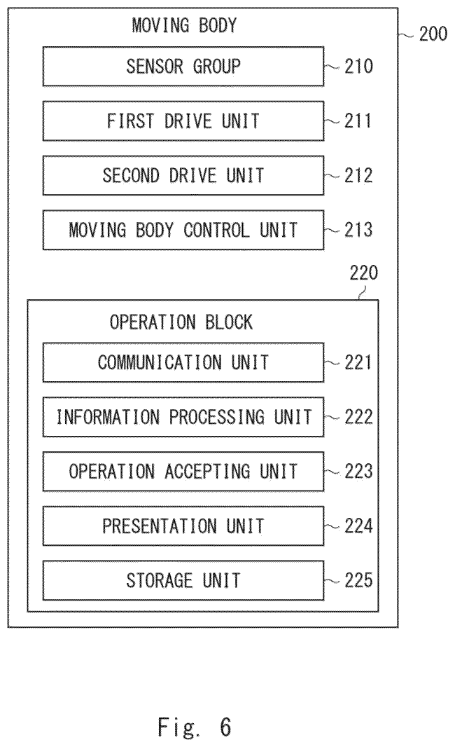

Next, the function of the moving body 200 will be further described with reference to FIG. 6. FIG. 6 is a block diagram of the moving body 200. The moving body 200 includes, as main functional configurations, a sensor group 210, a first drive unit 211, a second drive unit 212, a moving body control unit 213, and the operation block 220.

The sensor group 210 includes a sensor for exhibiting the function of the moving body 200. The sensor group 210 includes, for example, an antenna that receives a satellite signal of a Global Navigation Satellite System (GNSS) and a gyro sensor for recognizing the posture of the moving body 200.

The first drive unit 211 includes a function for driving the propeller unit 202. The second drive unit 212 includes a function for driving the traveling unit 203. The moving body control unit 213 controls the operation of the moving body 200. The moving body control unit 213 controls the entire moving body 200 in cooperation with the operation block 220.

The operation block 220 includes, as main functional configurations, a communication unit 221, an information processing unit 222, an operation accepting unit 223, a presentation unit 224, and a storage unit 225.

The communication unit 221 includes an interface for connecting to the network N1 by wireless communication. The information processing unit 222 generates an instruction for each configuration from various information acquired by the operation block 220 and controls the moving body 200.

The operation accepting unit 223 accepts an input of user information from the user. The operation accepting unit 223 may also accept an operation of the operator if the operator maneuvers the moving body 200. The operation accepting unit 223 is, for example, a touch panel superimposed on a display. The operation accepting unit 223 may include a keyboard, a switch, a handle, a lever, or the like.

The presentation unit 224 is configured to present various types of information to a user or an operator (also referred to as a user or the like). The presentation unit 224 includes, for example, a display for allowing the user or the like to visually recognize predetermined information. The presentation unit 224 may also include a speaker, a light, a vibrator, or the like.

The storage unit 225 includes, for example, a non-volatile memory such as a flash memory or an SSD. The storage unit 225 stores a program for the moving body 200 to exhibit the function of the present disclosure. In addition, the storage unit 225 stores a unique identifier, machine body information, or the like of the moving body 200.

The configuration of the moving body 200 has been described above. In addition to the above-described configuration, the moving body 200 may include, for example, a camera, a biometric sensor, or the like for authenticating the user or the like.

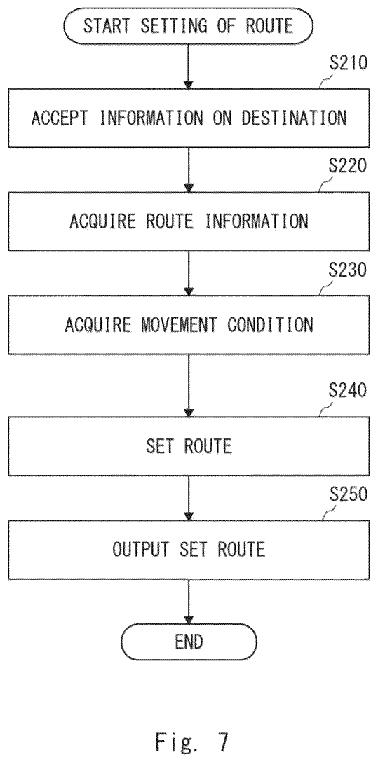

Next, a route setting processing executed by the guidance system 120 will be described with reference to FIG. 7. FIG. 7 is a flowchart of a guidance method executed by the guidance system 120. The flowchart illustrated in FIG. 7 is processing executed by the guidance system 120 in the case where the user sets a route for moving to a destination using a plurality of transportation means including the moving body 200. The flowchart illustrated in FIG. 7 starts, for example, in the case where the user riding on the moving body 200 sets a route before the moving body 200 departs.

First, the guidance system 120 accepts information on destination from the moving body 200 (step S210). The guidance system 120 may accept information such as a transit point in addition to information on the destination.

Next, the route information acquisition unit 12 of the guidance system 120 acquires route information that is information on a route to be a route candidate to the accepted destination (step S220). The route information may be stored in advance in the storage unit 20 of the guidance system 120.

Next, the condition acquisition unit 13 of the guidance system 120 acquires a movement condition related to the route candidate to the destination (step S230). For example, the condition acquisition unit 13 acquires, from the reservation system 310, the weather information providing system 320, and the traffic information providing system 330, information regarding the movement condition used in the setting of the route.

Next, the route setting unit 14 sets a route to the destination including the moving body 200 and other transportation means (step S240). At this time, the route setting unit 14 may acquire transfer guide information or the like of another transportation means from the traffic information providing system 330.

Next, the output unit 15 outputs information regarding the set route to the moving body 200 (step S250). When the information regarding the set route is output, the guidance system 120 ends the processing related to the setting of the route.

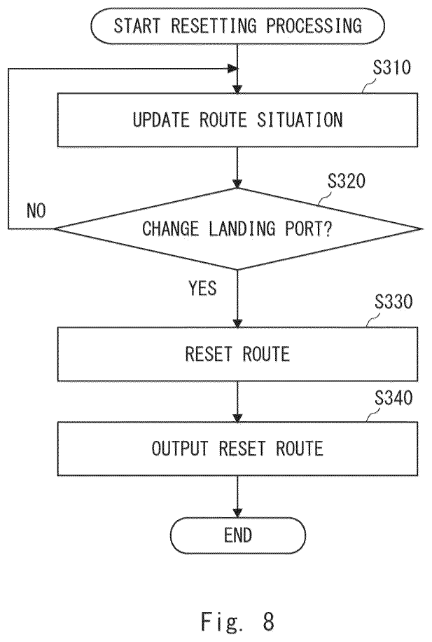

Next, a route resetting processing executed by the guidance system 120 will be described with reference to FIG. 8. FIG. 8 is a flowchart of a guidance method executed by the guidance system 120. The flowchart illustrated in FIG. 8 starts after the moving body 200, for which the route setting has been completed, started moving. At this time, the moving body 200 transports the user to a predetermined landing port. The user ultimately heads toward the destination via the predetermined landing port.

First, the route information acquisition unit 12 of the guidance system 120 updates the route situation (step S310). The processing of updating the route situation is, for example, processing of acquiring weather information from the weather information providing system 320. Alternatively, the processing of updating the route situation is processing of receiving a notification of a change in the usage situation of the landing port from the port management system 300.

Next, the resetting determination unit 10 of the guidance system 120 determines whether to change the landing port (step S320). In a case where the resetting determination unit 10 does not determine to change the landing port (step S320: NO), the guidance system 120 returns to step S310. On the other hand, if the resetting determination unit 10 determines to change the landing port (step S320: YES), the guidance system 120 proceeds to step S330.

In step S330, the route setting unit 14 of the guidance system 120 resets the route (step S330). At this time, in a case where it is necessary to acquire the user information, the possible movement route, and the movement condition again in order to reset the route, the route setting unit 14 acquires the respective information again from the user information acquisition unit 11, the route information acquisition unit 12, and the condition acquisition unit 13. Upon resetting the route, the route setting unit 14 supplies information regarding the reset route to the output unit 15.

Next, the output unit 15 outputs the information regarding the reset route received from the route setting unit 14 to the operation block 220 (step S340). After the route setting unit 14 executes this processing, the guidance system 120 ends the resetting processing.

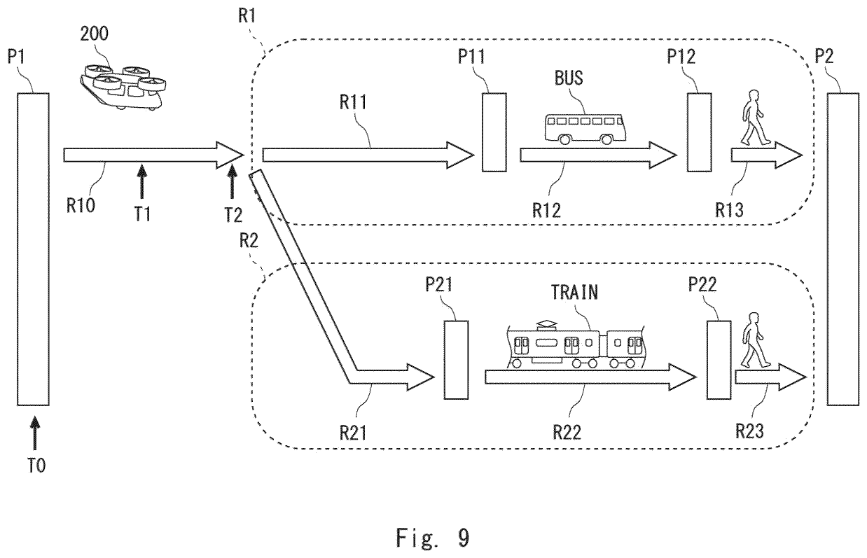

Next, processing of the guidance system 120 in a case of resetting the route will be described with reference to FIG. 9. FIG. 9 is a diagram for explaining a set route.

FIG. 9 illustrates a route from a departure point P1 to a destination P2. FIG. 9 illustrates that the moving body 200 departs from the departure point P1 and moves on a route R10. In addition, FIG. 9 includes a first route R1 and a second route R2 as routes to the destination P2 after the route R10. The first route is a route set at the time of departure. The second route is a route reset after departure.

The first route R1 includes an operation route R11 of the moving body 200, a landing port P11 of the moving body 200, a bus route R12, a bus stop P12, and a walking route R13. The second route R2 includes an operation route R21 of the moving body 200, a landing port P21 of the moving body 200, a train route R22, a train stop station P22, and a walking route R23.

In the above-described configuration, for example, at time T0, the user U1 boards the moving body 200 at the departure point P1 and sets a route to the destination P2. At this time, the guidance system 120 sets a route along the flowchart illustrated in FIG. 7.

Next, after the moving body 200 departs from the departure point P1, the port management system 300 notifies that the landing port P11 cannot be used due to bad weather at time T1 during the movement on the route R10. Therefore, the guidance system 120 performs processing of resetting the route to the destination P2. At this time, the guidance system 120 resets the route along the flowchart illustrated in FIG. 8. As a result, after time T2 after time T1, the user U1 advances on the second route R2 and moves to the destination P2.

As described above, the guidance system 120 can execute route setting across a plurality of transportation means including the moving body 200. Furthermore, at this time, the guidance system 120 sets or resets the route in consideration of the congestion situation, the weather information, and the like in the route candidate of the moving body 200 acquired by the route information acquisition unit 12 and the condition acquisition unit 13.

As described above, according to the present disclosure, it is possible to provide a guidance system, a guidance method, and a program capable of setting an efficient movement route.

### Third Example Embodiment

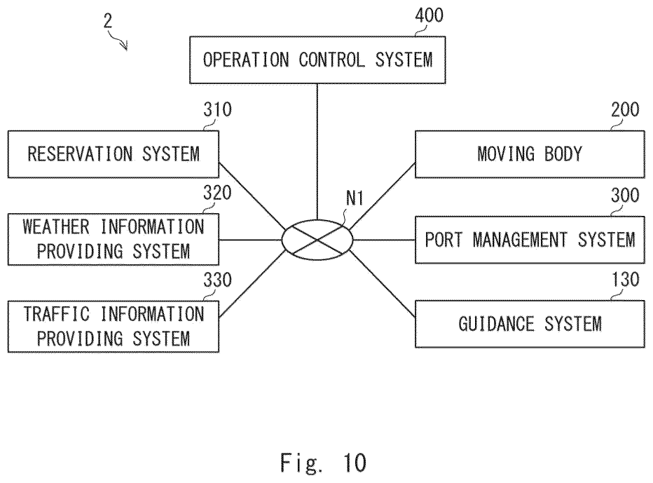

Next, a third example embodiment will be described. FIG. 10 is a block diagram of an operation system 2. The operation system 2 is different from the operation system 1 described above in that it includes an operation control system 400. In addition, the operation system 2 includes a guidance system 130 instead of the guidance system 120.

The operation control system 400 is a system that controls a movement situation of the entire moving body including the moving body 200. The moving body 200 in the operation system 2 travels along a route permitted by the operation control system 400. That is, the guidance system 130 of the operation system 2 performs an application processing for obtaining permission from the operation control system 400 to perform route setting. According to such a configuration, the operation system 2 collectively manages movement of a plurality of moving bodies including drones. As a result, the operation system 2 suppresses a decrease in safety of the moving body.

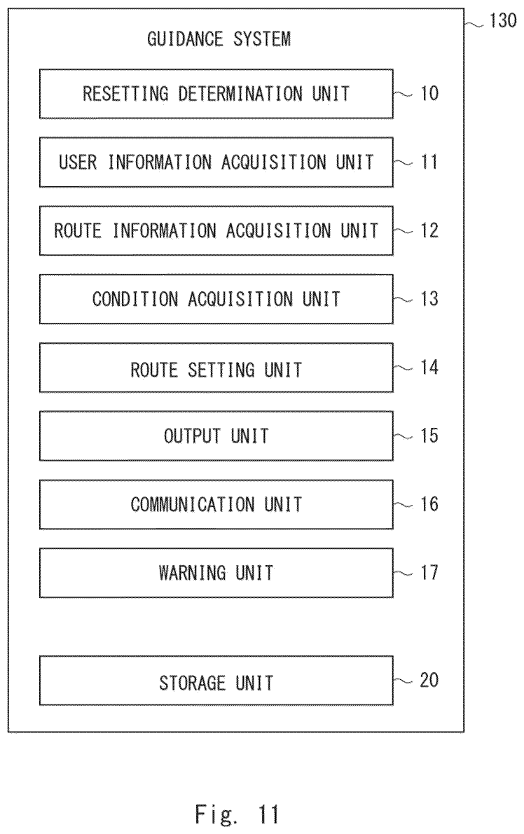

Next, the guidance system 130 will be described with reference to FIG. 11. FIG. 11 is a block diagram of the guidance system 130. The guidance system 130 is different from the guidance system 120 in that it includes a warning unit 17. Furthermore, the guidance system 130 has the following functions.

The route setting unit 14 of the guidance system 130 notifies a predetermined operation control system 400 of the operation plan and requests for a permission. In this case, after acquiring the permission for operation from the operation control system 400, the output unit 15 outputs a route to the moving body 200 on which the user U1 is boarding.

Similarly, at that time of resetting the route, the route setting unit 14 notifies the operation control system 400 of the operation plan related to the resetting and requests for a permission. In this case, after acquiring the permission for operation after the resetting from the operation control system 400, the output unit 15 outputs the reset route to the user.

With the above-described configuration, the guidance system 130 sets an efficient movement route while suppressing a fixed price of safety.

Furthermore, the route setting unit 14 notifies the operation control system of the execution of the operation plan after acquiring the permission for operation after the setting from the operation control system 400.

Similarly for the reset route, the route setting unit 14 acquires the permission for operation after the resetting from the operation control system 400, and then notifies the operation control system 400 of the execution of the operation plan after the resetting.

As described above, the guidance system 130 notifies the operation control system 400 of movement along the set movement route while suppressing the fixed price of safety. As a result, the operation system 2 controls the operation of other moving bodies in consideration of the operation plan of the moving body 200.

Furthermore, the output unit 15 also outputs the acquisition of the permission for operation from the operation control system in outputting the route related to the setting or the resetting. As a result, the guidance system 130 can give the user U1 a sense of security in the operation of the moving body 200.

In addition, after acquiring the permission for the operation plan related to the setting or the resetting from the operation control system, the guidance system 130 may output information indicating the movement along this route to other guidance systems to share. As a result, the guidance system 130 can urge another moving body to take into consideration the operation of the moving body 200.

In addition, after acquiring the permission for the operation plan related to the setting or the resetting from the operation control system, the guidance system 130 may output information on this route to the user terminal to share. The user terminal is a wearable device such as a smartphone, a tablet terminal, or smart glasses carried by the user. In this way, by also outputting the operation plan to the user terminal, the guidance system 130 can guide the user U1 who uses another transportation means to the route to the destination P2 after using the moving body 200.

The warning unit 17 of the guidance system 130 outputs a warning to the operator of the moving body 200 in the event that the moving body 200 deviates from the operation plan related to the resetting by a predetermined threshold distance or more. In addition, the warning unit 17 outputs a warning to the operator of the moving body 200 in the event that the moving body 200 approaches the alternative location outside the time of the plan. At this time, the warning method performed by the warning unit 17 can be achieved by using the presentation unit 224 in the operation block 220. That is, the warning output by the warning unit 17 may be to display a warning on the display unit of the operation block 220. The warning output by the warning unit 17 may be to cause the speaker of the operation block 220 to output a warning sound. With such a configuration, the guidance system 130 can perform route guidance while taking more consideration to safety.

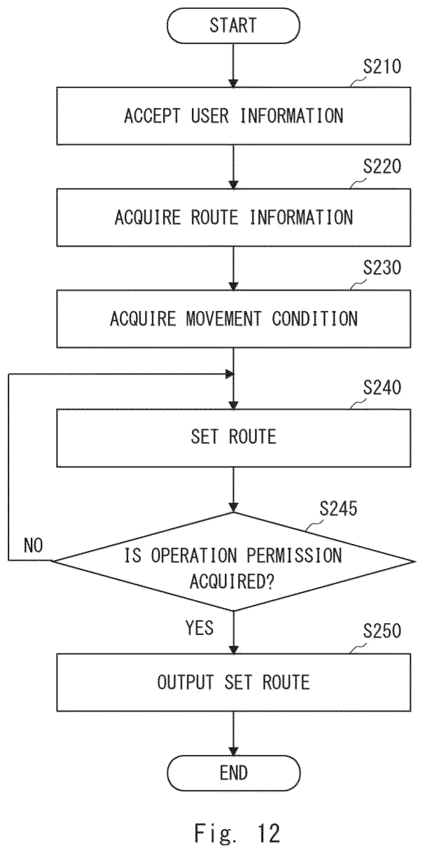

Next, a route setting method executed by the guidance system 130 will be described with reference to FIG. 12. FIG. 12 is a flowchart of a guidance method executed by the guidance system 130. The flowchart illustrated in FIG. 12 is different from the flowchart of FIG. 7 in that step S245 is provided between step S240 and step S50.

In step S240, the route setting unit 14 sets a route to a destination including the moving body 200 and other transportation means (step S240).

After step S240, in step S245, the route setting unit 14 determines whether a permission has been acquired for the set route from the operation control system 400 (step S245). In a case where the route setting unit 14 does not determine that the permission has been acquired from the operation control system 400 (step S245: NO), the guidance system 130 returns to step S240 and sets a route again. On the other hand, in a case where the route setting unit 14 determines that the permission for operation has been acquired from the operation control system 400 (step S245: YES), the guidance system 130 proceeds to step S250.

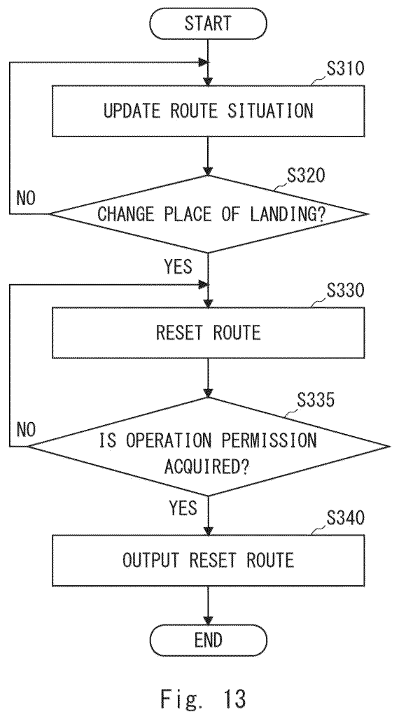

A case where the guidance system 130 resets the route will be described with reference to FIG. 13. FIG. 13 is a flowchart of a guidance method executed by the guidance system 130. The flowchart illustrated in FIG. 13 is different from the flowchart of FIG. 8 in that step S335 is provided between step S330 and step S340.

In step S330, the route setting unit 14 resets the route (step S330). Next, the route setting unit 14 determines whether a permission has been acquired for a route related to the resetting from the operation control system 400 (step S335). In a case where the route setting unit 14 does not determine that the permission has been acquired from the operation control system 400 (step S335: NO), the guidance system 130 returns to step S330 and repeats resetting of a route. On the other hand, in a case where the route setting unit 14 determines that the permission for operation has been acquired from the operation control system 400 (step S335: YES), the guidance system 130 proceeds to step S340.

With the above-described configuration, the guidance system 130 can set a route while taking more consideration to safety. Therefore, according to the present disclosure, it is possible to provide a guidance system, a guidance method, and a program capable of setting a highly safe and efficient movement route.

### Example of Hardware Configuration

Hereinafter, a case where each functional component in the present disclosure is implemented by a combination of hardware and software will be described.

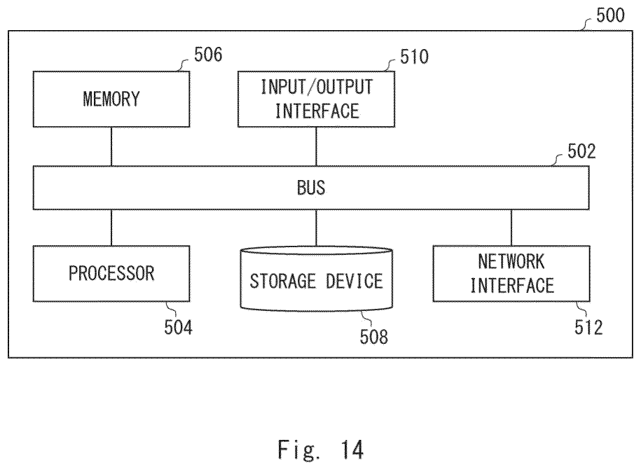

FIG. 14 is a block diagram illustrating a hardware configuration of a computer. An update information generation device and a static information management device in the present disclosure can achieve the above-described functions by a computer 500 including the hardware configuration illustrated in the drawing. The computer 500 may be a portable computer such as a smartphone or a tablet terminal or may be a stationary computer such as a PC. The computer 500 may be a dedicated computer designed to implement each device, or may be a general-purpose computer. The computer 500 can implement a desired function by installing a predetermined application.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is any of various processors such as a CPU, a GPU, or an FPGA. The memory 506 is a primary storage device achieved using a Random Access Memory (RAM) or the like.

The storage device 508 is an auxiliary storage device achieved using a hard disk, an SSD, a memory card, a Read Only Memory (ROM), or the like. The storage device 508 stores a program for implementing a desired function. The processor 504 reads the program into the memory 506 and executes the program to implement each functional component of each of the devices.

The input/output interface 510 is an interface for connecting the computer 500 and an input/output device. For example, an input device such as a keyboard and an output device such as a display device are connected to the input/output interface 510.

The network interface 512 is an interface for connecting the computer 500 to a network.

Although the invention of the present application has been particularly shown and described above with reference to example embodiments thereof, the invention of the present application is not limited to the above. It will be understood by those of ordinary skill in the art that various changes in form and details may be made therein without departing from the spirit and scope of the invention of the present application as defined by the claims.

Some or all of the above example embodiments may be described as the following Supplementary Notes, but are not limited to the following.

### Supplementary Note 1

A guidance system including,
a user information acquisition unit for acquiring user information including a route along which a moving body flying in the sky and transporting a user transports the user, a destination of the user, and a route of another movement means used by the user,
a route information acquisition unit for acquiring a possible movement route of the moving body from a predetermined database,
a condition acquisition unit for acquiring a movement condition including environment information of the possible movement route,
a route setting unit for, upon changing an initial arrival location of the moving body to an alternative location, resetting a route to the alternative location based on the user information, the possible movement route, and the movement condition, and
an output unit for outputting a route to the alternative location related to the resetting to the user.

### Supplementary Note 2

The guidance system according to supplementary note 1, in which
the condition acquisition unit acquires weather information of a route of the moving body from a weather information providing system, and
the route setting unit performs the resetting based on the weather information at a scheduled time at which the moving body exists in the route to the alternative location.

### Supplementary Note 3

The guidance system according to supplementary note 2, in which the route setting unit selects the alternative location where the moving body can land based on weather at a scheduled time in the event that the moving body lands at the alternative location.

### Supplementary Note 4

The guidance system according to supplementary note 2, in which
the condition acquisition unit acquires, as the weather information, at least one piece of information among wind speed, fog, rainfall, snowfall, and yellow sand, and
the route setting unit performs the resetting in consideration of the weather information.

### Supplementary Note 5

The guidance system according to supplementary note 4, in which
the condition acquisition unit further acquires information regarding a moving ability of the moving body, and
the route setting unit performs the resetting in further consideration of the moving ability of the moving body.

### Supplementary Note 6

The guidance system according to any one of supplementary notes 1 to 5, in which
the route information acquisition unit further stores a position of a take-off and landing site of the moving body including the alternative location and a time required for the user to take-off and land,
the route setting unit performs the resetting including a transfer between the alternative location and the another movement means, and
the output unit outputs a route to the destination including the alternative location related to the resetting to the user.

### Supplementary Note 7

The guidance system according to supplementary note 1, in which
the route setting unit notifies a predetermined operation control system of an operation plan related to the resetting and requests for a permission, and
the output unit acquires the permission for the operation after the resetting from the operation control system, and then outputs the route after the resetting to the user.

### Supplementary Note 8

The guidance system according to supplementary note 7, in which the route setting unit notifies, after acquiring the permission for the operation after the resetting from the operation control system, the operation control system of an execution of an operation plan after the resetting.

### Supplementary Note 9

The guidance system according to supplementary note 7 or 8, in which, at that time of outputting the route related to the resetting, the output unit also outputs that the permission for the operation has been acquired from the operation control system.

### Supplementary Note 10

The guidance system according to supplementary note 7 or 8, in which the output unit, after acquiring the permission for an operation plan related to the resetting from the operation control system, outputs information on the route related to the resetting to another guidance system to share.

### Supplementary Note 11

The guidance system according to supplementary note 7 or 8, in which the output unit, after acquiring the permission for an operation plan related to the resetting from the operation control system, outputs information on the route related to the resetting to a user terminal carried by the user.

### Supplementary Note 12

The guidance system according to supplementary note 1, further including a warning unit for outputting a warning to an operator of the moving body in the event that the moving body deviates from the operation plan related to the resetting by a predetermined threshold distance or more.

### Supplementary Note 13

The guidance system according to supplementary note 1, further including a warning unit for outputting a warning to an operator of the moving body in the event that the moving body approaches the alternative location outside a time of the plan.

### Supplementary Note 14

A guidance method including,
by a computer,
acquiring user information including a route along which a moving body flying in the sky and transporting a user transports the user, a destination of the user, and a route of another movement means used by the user,
acquiring a possible movement route of the moving body from a predetermined database,
acquiring a movement condition including environment information of the possible movement route,
resetting, upon changing an initial arrival location of the moving body to an alternative location, a route to the alternative location based on the user information, the possible movement route, and the movement condition, and
outputting a route to the alternative location related to the resetting to the user.

### Supplementary Note 15

A program for causing a computer to execute a guidance method including,
acquiring user information including a route along which a moving body flying in the sky and transporting a user transports the user, a destination of the user, and a route of another movement means used by the user,
acquiring a possible movement route of the moving body from a predetermined database,
acquiring a movement condition including environment information of the possible movement route,
resetting, upon changing an initial arrival location of the moving body to an alternative location, a route to the alternative location based on the user information, the possible movement route, and the movement condition, and
outputting a route to the alternative location related to the resetting to the user.

This application is based upon and claims the benefit of priority from Japanese patent application No. 2023-087592, filed on May 29, 2023, the disclosure of which is incorporated herein in its entirety by reference.

The present disclosure can be used for, for example, a route guidance system of a flying car.

### REFERENCE SIGNS LIST

1 operation system
2 operation system
10 resetting determination unit
11 user information acquisition unit
12 route information acquisition unit
13 condition acquisition unit
14 route setting unit
15 output unit
16 communication unit
17 warning unit
20 storage unit
110 guidance system
120 guidance system
130 guidance system
200 moving body
201 cabin
202 propeller unit
203 traveling unit
210 sensor group
211 first drive unit
212 second drive unit
213 moving body control unit
220 operation block
221 communication unit
222 information processing unit
223 operation accepting unit
224 presentation unit
225 storage unit
300 port management system
310 reservation system
320 weather information providing system
330 traffic information providing system
400 operation control system
500 computer
502 bus
504 processor
506 memory
508 storage device
510 input/output interface
512 network interface
N1 network

What is claimed is:

1. A guidance system comprising:
at least one memory storing instructions, and
at least one processor configured to execute the instructions to;
a user information acquisition configured to acquire user information including a route along which a moving body flying in the sky and transporting a user transports the user, a destination of the user, and a route of another movement used by the user;
a route information acquisition configured to acquire a possible movement route of the moving body from a predetermined database;
a condition acquisition configured to acquire a movement condition including environment information of the possible movement route;
a route setting configured to, upon changing an initial arrival location of the moving body to an alternative location, reset a route to the alternative location based on the user information, the possible movement route, and the movement condition; and
an output configured to output a route to the alternative location related to the resetting to the user.

2. The guidance system according to claim 1, wherein the at least one processor is further configured to execute the instructions to
cause the condition acquisition to acquire weather information of a route of the moving body from a weather information providing system, and
cause the route setting to perform the resetting based on the weather information at a scheduled time at which the moving body exists in the route to the alternative location.

3. The guidance system according to claim 2, wherein the at least one processor is further configured to execute the instructions to
cause the route setting to select the alternative location where the moving body can land based on weather at a scheduled time in the event that the moving body lands at the alternative location.

4. The guidance system according to claim 2, wherein the at least one processor is further configured to execute the instructions to
cause the condition acquisition to acquire, as the weather information, at least one piece of information among wind speed, fog, rainfall, snowfall, and yellow sand, and
cause the route setting to perform the resetting in consideration of the weather information.

5. The guidance system according to claim 4, wherein the at least one processor is further configured to execute the instructions to
cause the condition acquisition to further acquire information regarding a moving ability of the moving body, and
cause the route setting to perform the resetting in further consideration of the moving ability of the moving body.

6. The guidance system according to claim 1, wherein the at least one processor is further configured to execute the instructions to
cause the route information acquisition to further store a position of a take-off and landing site of the moving body including the alternative location and a time required for the user to take off and land,
cause the route setting to perform the resetting including a transfer between the alternative location and the another movement, and
cause the output to output a route to the destination including the alternative location related to the resetting to the user.

7. The guidance system according to claim 1, wherein the at least one processor is further configured to execute the instructions to
cause the route setting to notify a predetermined operation control system of an operation plan related to the resetting and requests for a permission, and
cause the output to acquire the permission for the operation after the resetting from the operation control system, and then to output the route after the resetting to the user.

8. The guidance system according to claim 7, wherein the at least one processor is further configured to execute the instructions to
cause the route setting to notify, after acquiring the permission for the operation after the resetting from the operation control system, the operation control system of an execution of an operation plan after the resetting.

9. The guidance system according to claim 7, wherein the at least one processor is further configured to execute the instructions to
in outputting the route related to the resetting, cause the output to also output that the permission for the operation has been acquired from the operation control system.

10. The guidance system according to claim 7, wherein the at least one processor is further configured to execute the instructions to
cause the output, after acquiring the permission for an operation plan related to the resetting from the operation control system, to output information on the route related to the resetting to another guidance system to share.

11. The guidance system according to claim 7, wherein the at least one processor is further configured to execute the instructions to
cause the output, after acquiring the permission for an operation plan related to the resetting from the operation control system, to output information on the route related to the resetting to a user terminal carried by the user.

12. The guidance system according to claim 1, further comprising a warning outputs a warning to an operator of the moving body in the event that the moving body deviates from the operation plan related to the resetting by a predetermined threshold distance or more.

13. The guidance system according to claim 1, further comprising a warning outputs a warning to an operator of the moving body in the event that the moving body approaches the alternative location outside a time of the plan.

14. A guidance method comprising:
by a computer,
acquiring user information including a route along which a moving body flying in the sky and transporting a user transports the user, a destination of the user, and a route of another movement used by the user;
acquiring a possible movement route of the moving body from a predetermined database;
acquiring a movement condition including environment information of the possible movement route;
resetting, upon changing an initial arrival location of the moving body to an alternative location, a route to the alternative location based on the user information, the possible movement route, and the movement condition; and
outputting a route to the alternative location related to the resetting to the user.

15. The guidance method according to claim 14, further comprising:
acquiring weather information of a route of the moving body from a weather information providing system; and
performing the resetting based on the weather information at a scheduled time at which the moving body exists in the route to the alternative location.

16. The guidance method according to claim 15, further comprising selecting the alternative location where the moving body can land based on weather at a scheduled time in the event that the moving body lands at the alternative location.

17. The guidance method according to claim 15, further comprising:
acquiring, as the weather information, at least one piece of information among wind speed, fog, rainfall, snowfall, and yellow sand; and
performing the resetting in consideration of the weather information.

18. The guidance method according to claim 17, further comprising:
further acquiring information regarding a moving ability of the moving body; and
performing the resetting in further consideration of the moving ability of the moving body.

19. The guidance method according to claim 14, further comprising:
further storing a position of a take-off and landing site of the moving body including the alternative location and a time required for the user to take off and land;
performing the resetting including a transfer between the alternative location and the another movement; and
outputting a route to the destination including the alternative location related to the resetting to the user.

20. A non-transitory computer-readable medium storing instructions for causing a computer to execute a guidance method comprising:
acquiring user information including a route along which a moving body flying in the sky and transporting a user transports the user, a destination of the user, and a route of another movement used by the user;
acquiring a possible movement route of the moving body from a predetermined database;
acquiring a movement condition including environment information of the possible movement route;
resetting, upon changing an initial arrival location of the moving body to an alternative location, a route to the alternative location based on the user information, the possible movement route, and the movement condition; and
outputting a route to the alternative location related to the resetting to the user.
